(19) United States
(12) Patent Application Publication
(10) Pub. No.: US 2011/0285733 A1
(43) Pub. Date: Nov. 24, 2011

(54) DIGITAL STICKY NOTE WITH ELECTRIC PAPER DISPLAY

(75) Inventors: Kai-Cheng CHUANG, Hsinchu City (TW); Tzu-Ming Wang, Hsinchu City (TW); Po-Wen Hsiao, Hsinchu City (TW); Gwo-Feng Hwang, Hsinchu City (TW)

(73) Assignee: E Ink Holdings Inc., Hsinchu (TW)

(21) Appl. No.: 12/911,113

(22) Filed: Oct. 25, 2010

(30) Foreign Application Priority Data
May 20, 2010 (TW) 099116160

(51) Int. Cl. G09G 5/00

(52) U.S. Cl. 345/581

(57) ABSTRACT

A digital sticky note has an electric paper displayer having a substrate. In addition, a display is configured on the substrate for showing an image picture without power. Further, a wireless receiver module, a process unit and a display circuit are also configured on the substrate. Wherein, the wireless receiver module receives a memo information through a wireless transmission interface, and transmits the memo information to the processor unit. Therefore, the processor unit controls the display circuit to show the memo information on the display array according to the obtained memo information.

### CROSS-REFERENCE TO RELATED APPLICATION

This application claims the priority benefit of Taiwan application serial no. 099116160, filed on May 20, 2010. The entirety of the above-mentioned patent application is incorporated herein by reference and made a part of this specification.

### BACKGROUND

1. Technical Field

The present invention relates to a sticky note, and more particularly to a sticky note implemented by an electric-paper.

2. Description of the Related Art

Sticky note is a convenient and practical production which is implemented by a small paper. A special back-adhensive material having proper viscous is coated on one side of the sticky note. Thus, when the sticky note is torn from a surface, no resident back-adhensive is on the surface. Therefore, user can use the sticky note to transmit some massage or be a memo. The sticky note is already became a indispensable daily thing of general people in their day life.

Although the prior sticky note is so convenient, the prior sticky note cannot be used repeatedly. In another word, when the items written on the sticky are all completed, or became worthless, the used sticky note is discarded. Therefore, the prior sticky note causes waste of resources, and huge impacts on the environment greatly.

In addition, people must need hand-writing mater in prior sticky note. However, in nowadays information society, when user wants recording some massages original saved in computer or mobile phone on prior sticky note, user needs hand-writing the massages on the prior sticky note.

### BRIEF SUMMARY

Therefore, the present invention provides a digital sticky note for user to employ repeatedly so as to prevent the waste of resource.

In addition, the present invention further provides a digital memo system which can record message saved in variation information production on sticky note without hand-writing.

The present invention provides a digital sticky note comprising an electric paper displayer having a substrate. In addition, a display is configured on the substrate for showing an image picture without power. Further, a wireless receiver module, a process unit and a display circuit are also configured on the substrate. Wherein, the wireless receiver module receives a memo information through a wireless transmission interface, and transmits the memo information to the processor unit. Therefore, the processor unit controls the display circuit to show the memo information on the display array according to the obtained memo information.

In one embodiment of the present invention, the digital sticky note further comprises a wire coil set configured on the substrate and on a signal transmission path between the wireless receiver module and the processor unit. When the wireless receiver module receives the memo information, the wire coil set generates sensing current for the electric paper displayer to work.

In another embodiment, a battery is configured in the digital sticky note for supplying the power for the electric paper displayer to work.

In another view point, the present invention provides a digital memo system comprising a electric apparatus and displayer. Wherein, the electric apparatus generates a memo information. In addition, the displayer links with the electric apparatus for receiving the memo information through a wireless transmission interface, and showing the memo information without power.

In some embodiments the electric apparatus is one of a desktop computer, a portable computer, and a mobile apparatus.

Since the present invention employs the electric paper displayer to show the memo information, the sticky note can be used repeatedly, and show the memo information without hand-writing.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block diagram of digital memo system according to one preferred embodiment of the present invention.

FIG. 2 is a circuit block of a digital sticky note according to one preferred embodiment of the present invention.

FIG. 3 is a circuit block diagram of a digital sticky note according to another embodiment of the present invention.

### DETAILED DESCRIPTION

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

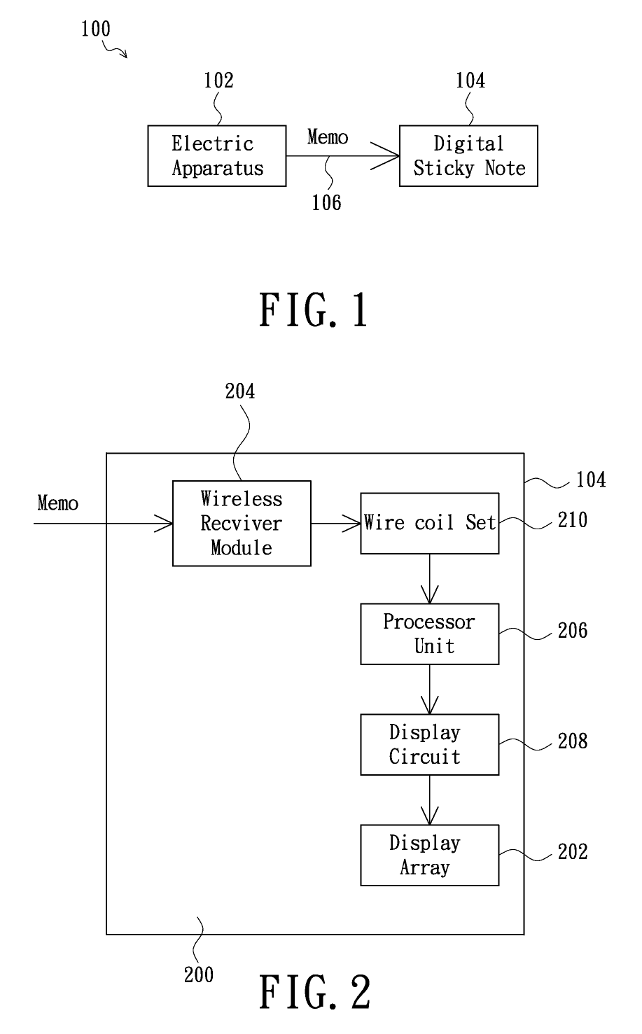

FIG. 1 is a block diagram of digital memo system according to one preferred embodiment of the present invention. Referring to the FIG. 1, the digital memo system 100 of the embodiment comprises electric apparatus 102 and digital sticky note 104. Wherein, the electric apparatus 102 is, for example, a desktop computer, a portable computer, or a mobile apparatus. In addition, the electric apparatus 102 is linked to the digital sticky note 104 through a wireless transmission interface 106, for example infrared or blue tooth transmission interfaces. In particular, the digital sticky note is implemented by a displayer.

FIG. 2 is a circuit block of a digital sticky note according to one preferred embodiment of the present invention. Referring to FIG. 2, the digital sticky note 104 provided by the present invention is implemented by an electric-paper displayer. The digital sticky note 104 has a substrate 200, which preferred but not limited is a flexible substrate. In the embodiment, there is an attachment area in the substrate 200, and a back-adhensive material is coated on the attachment area. Therefore, the sticky note can attach on at least one surface repeatedly.

In other embodiments, some designs can displace the back-adhensive material for the digital sticky note 104 for attaching on a surface repeatedly. For example, a magnet can be used to displace the back-adhensive material. In addition, a clip structure also can displace the back-adhensive material, so that the digital sticky note 104 can clip on an object.

Referring to FIG. 2 continually, a display array 202 with a electric ink technology is configured on the substrate 200. Thus, the display 202 can show a image picture without power. In some embodiments, the display 202 has a plurality of electrophoretic cells arranged by an array.

In addition, a wireless receiver module 204, a processor unit 206 and a display circuit 208 are also configured on the substrate 200. The wireless receiver module 204, such an infrared receiver module or blue tooth receiver module, is linked with the electric apparatus 102 through wireless 106 as showing in FIG. 1.

Referring to FIGS. 1 and 2, a user can operate the electric apparatus 102 to send a memo information Memo, for example the user can use a mobile phone send a short message or operate computer output an address book to be the memo information Memo. When the memo information Memo is output, the memo information Memo is transmitted to the digital sticky note 104 through the wireless receiver module 204. Then, the processor unit 204 obtains the memo information Memo from the wireless receiver module 204. In addition, the processor unit 204 outputs a control signal to the display circuit 208 according to the memo information Memo, so as to control the display circuit 208 showing the memo information Memo.

Since the display array 202 uses the electric ink technology, the display array 202 show the image picture without power. In other word, the digital sticky note 104 of the embodiment need power supply, only in a situation that the digital sticky 104 receives the memo information Memo output by the electric apparatus 102 so as to change original image picture. Therefore, in the embodiment, a wire coil set is configured on the substrate, and configured on a signal transmission path between the wireless receiver module 204 and processor unit 206.

In this case, when the memo information Memo is sent to the wireless receiver module 204, an electromagnetic wave is generated. Meanwhile, the wire coil set 210 senses the electromagnetic wave and generates a sense current. So that, the sense current is used to supply power to the elements of digital sticky note 104 for changing the image picture showed by the display array 202. After upgrading the image picture of the display array 202, the electric apparatus 102 stops sending the memo information Memo to the sticky note 104, so that electromagnetic wave is broke. The wire coil set 210 also stops generating the sensing current because the electromagnetic wave is broke. However, the display array 202 still shows the original image picture.

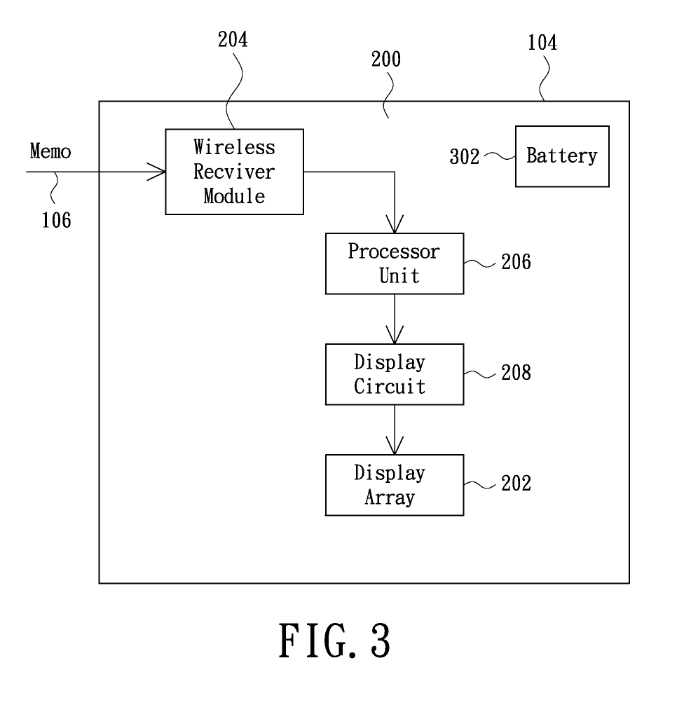

FIG. 3 is a circuit block diagram of a digital sticky note according to another embodiment of the present invention. Referring to the FIG. 3, in this embodiment, a battery 302 is used to displace the wire coil set 210 in FIG. 2, to supply necessary power for the elements of the digital sticky note. Since the display array 202 uses the electric ink technology, the digital sticky note of the embodiment is used under a environment with outside light source generally. Thus, the battery 302 is implemented by solar cells. Therefore, when the solar cells senses outside light source, a current is generated for other elements of the digital sticky note.

Due to the present invention uses the electric paper display to be the digital sticky note, the digital sticky note can be employed repeatedly to prevent the waste of resource. In addition, the present invention can receive the memo information from the electric apparatus, so that the user doesn't hand-write memo item.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A digital sticky note, comprising:
an electric paper displayer, having a substrate on which a display array is configured, wherein the display array shows a image picture without power;
a wireless receiver module, configured on the substrate for receiving a memo information through a wireless transmission interface;
a processor unit, configured on the substrate for obtaining the memo information from the wireless receiver module; and
a display circuit, configured on the substrate and coupled the processor unit and the display array for controlling the display array to show the memo information as the wireless receiver module receiving the memo information.

2. The digital sticky note as claimed in claim 1, further comprising a wire coil set is configured on the substrate, and on a path between the wireless receiver module and processor unit for generating sensing current as the wireless receiver module receiving the memo information for supplying power to the electrical-paper displayer to work.

3. The digital sticky note as claimed in claim 1, further comprising a battery is configured on the substrate for supplying power to the electrical-paper displayer to work.

4. The digital sticky note as claimed in claim 1, wherein the substrate is a flexible substrate having a sticky area, where a back-adhensive material is coated or a magnet is configured, so that the sticky note can attach on at least one surface repeatedly.

5. A digital memo system, comprising:
a electric apparatus, for generating a memo information;
a displayer, linked with the electric apparatus, so as to receive the memo information through a wireless transmission interface, and show the memo information without power.

6. The digital memo system as claimed in claim 5, wherein the electric apparatus is one of a desktop computer, a portable computer, and a mobile apparatus.

7. The digital memo system as claimed in claim 5, wherein the displayer comprises:
a flexible substrate;
a display array, configured on the flexile substrate for showing a image picture without power;
a wireless receiver module, configured on the flexible substrate for receiving the memo information through the wireless transmission interface;
a processor unit, configured on the flexible substrate for obtaining the memo information from the wireless receiver module; and
a display circuit, configured on the flexible substrate, and coupled to the processor unit and the display array for controlling the display array showing the memo information as the wireless receiver module receiving the memo information.

8. The digital memo system as claimed in claim 7, wherein the display array has a plurality of electrophoretic cells arranged by a array.

9. The digital memo system as claimed in claim 7, wherein the displayer further comprises a wire coil set being configured on the flexible substrate, and configured on a transmission path between the wireless receiver module and the processor unit for generating a sensing current to supply the power to the displayer to work as the wireless receiver module receiving the memo information.

10. The digital memo system as claimed in claim 7, wherein the displayer further comprises a battery for supplying the power to the displayer to work.
